(19) United States
(12) Patent Application Publication
(10) Pub. No.: US 2007/0015531 A1
(43) Pub. Date: Jan. 18, 2007

(54) Portable electronic device

(76) Inventor: Mark Disalvo, Cave Creek, AZ (US)

Correspondence Address: DONALD J LENKSZUS, PC, PO BOX 3064, Carefree, AZ, 85377, US

(21) Appl. No.: 11/179,146

(22) Filed: Jul. 12, 2005

(51) Int. Cl. H04B 1/38; H04M 1/00

(52) U.S. Cl. 455/550.1; 455/572

(57) ABSTRACT

An interactive system for use in conjunction in a movie theater having one or more venues, each venue comprising a projector and a theater screen simultaneously viewable by a group of individuals is provided in accordance with the principles of the invention. The illustrative embodiment of the system includes a master communication unit disposed in each venue. A plurality of handheld units is provided. Each handheld unit is programmed with a script, and identification information at one or more central locations. In accordance with one aspect of the invention, the handheld device is a portable electronic device comprising electronic circuitry that includes a super capacitor as the sole power source for the electronic circuitry.

### FIELD OF THE INVENTION

The present invention pertains to portable electronic devices, in general, and to portable electronic devices entertainment systems for use in large venue facilities, in particular.

### BACKGROUND OF THE INVENTION

Many theaters today and in the past have struggled to survive, so the high cost of digital projection technology is out of the question. If digital projection technology is to become a reality, theaters need a way to increase revenues without the requirement of large capital investments.

Since the infusion of the television in the 1960's, in-theater advertising in the United States has received little attention and achieved little success for movie theater owners. But recently, in-theater advertising has begun to receive the attention of some serious advertising talent and money; it's on the rise. Recent studies have proclaimed the effectiveness of in-theater advertising and its appeal to the young. This new surge in interest has the potential of bringing large revenue streams into the struggling and cash poor movie theater industry.

There is however a danger involved in increasing the amount and intensity of advertising in the moviegoers experience. People may grow weary of being pelted with commercial after commercial. It is therefore important to recognize a need to make the advertising process more effective, enjoyable, and even rewarding for the consumer without placing a financial burden on the theaters themselves.

It is one object of the invention to provide an interactive movie theater system utilizing existing projection systems

### SUMMARY OF THE INVENTION

This and other objects of the invention are achieved with a system and method in accordance with the principles of the invention.

An interactive system for use in a movie theater having one or more venues, each venue comprising a projector and a theater screen simultaneously viewable by a group of individuals is provided in accordance with the principles of the invention. The illustrative embodiment of the system includes a master communication unit disposed in each venue. A plurality of handheld units is provided. Each handheld unit is programmed with a script, and identification information at one or more central locations. Each handheld unit has manually operable inputs for generating responses and a wireless communication module. Each of handheld unit is operable to communicate with the master communication unit via the wireless communication module upon entering a venue zone proximate the master communication unit. The master communication unit comprises an optical communications link responsive to optical signals received via the theater screen to provide synchronization signals to each handheld unit in its corresponding venue zone to synchronize each such handheld unit to an appropriate place in the script.

Still further in accordance with the principles of the invention, the system includes a host computer, and a database comprising scripts. The system includes a programming station adapted to receive one or more handheld units and a communication link between the host computer and the programming station. The host computer is operable to download a plurality of scripts from the database to a handheld unit based upon a specific one of the venues.

Further in attendance with the principles of the invention, the illustrative embodiment of the system includes venue specific apparatus located in each of the venues. Each venue specific apparatus is operable to recognize each handheld unit within that venue that is identified as a participant in the corresponding venue zone.

In accordance with an aspect of the invention, each handheld device utilizes its corresponding script such that the user of the handheld device responds to images on the theater screen, and audio through the theater sound system, in the venue and/or audio or visual stimuli from the handheld device to operate the handheld unit in a interactive manner.

In accordance with another aspect of the invention a locator interface is disposed in each venue zone. The locator interface has input apparatus for entering identification information for specific ones of the plurality of handheld devices located in the venue zone. The system responds to entry of identification information to cause the corresponding handheld unit to generate a location signal and also configures each handheld unit for specific theatre operation as the handheld unit is carried into the theatre through a short range radio link.

Each handheld unit comprises an optical signal source to generate location signals.

In accordance with another aspect of the invention, each script is venue specific.

Each handheld unit comprises a microcontroller and a memory. The memory stores the script. The script is loaded into each handheld device via a programming station operable to receive one or more handheld units. Each handheld unit also includes transducers to provide for the providing of stimuli to a user and for receiving responses from the user.

In accordance with other aspects of the invention, the illustrative embodiment of the system comprises a host computer, a database comprising scripts, and a communication link between said host computer and said programming station. The host computer is operable to download a plurality of scripts to a handheld unit

In accordance with yet another aspect of the invention each handheld unit comprises a capacitor as its primary power source. The programming station comprises a high current charging source for charging the capacitor.

In accordance with yet another aspect of the invention, the memory comprises a concession menu. Each handheld device comprises a display, operable to display the concession menu. Manually operable inputs on the handheld device are operable to select and order items from the menu. The wireless communication module transmits items ordered to the master communication unit. A communication link is provided from the master communication unit to the programming station located at the concession area for capturing ordered items.

In accordance with the principles of the invention, a portable electronic device comprising electronic circuitry includes a super capacitor as the sole power source for the electronic circuitry.

The electronic circuitry of the illustrative embodiment of the invention comprises a communications module for providing communications over a wireless communication link, one or more manual inputs and a display. A housing contains the electronic circuitry and the super capacitor and is sized to permit the portable electronic device to be easily carried and operated with one hand by a user of the device. The device includes an interface apparatus to couple an external high current charging source to the super capacitor.

The portable electronic device of the illustrative embodiment comprises a microcontroller and a memory and the interface apparatus provides a communication link to the memory such that the memory may be loaded with a script.

In accordance with another aspect of the invention, the electronic circuitry comprises a wireless communication module. In the illustrative embodiment of the invention the wireless communication module, the microcontroller and the memory cooperate to synchronize operation of the portable electronic device with external influences.

In the illustrative embodiment of the invention the device comprises a display. The display is utilized to display a menu and the device includes input apparatus that is utilized to select items from the displayed menu and to cause the wireless communication module to transmit selected items and to identify the user.

### BRIEF DESCRIPTION OF THE DRAWING

The invention will be better understood from a reading of the following detailed description in conjunction with the drawing figures in which like references are utilized to designate like elements, and in which:

FIG. 1 illustrates a representative multi-screen movie theater to which the present invention is advantageously applied;

FIGS. 2 and 3 illustrate a handheld device in accordance with the principles of the invention;

FIG. 4 is a block diagram of the system in accordance with the principles of the invention;

FIG. 5 is a block diagram of a portion of the system of FIG. 4;

FIG. 6 is a block diagram of a second portion of the system of FIG. 4;

FIG. 7 is a block diagram of a third portion of the system of FIG. 4;

FIG. 8 is a more detailed block diagram of a portion of FIG. 7;

FIG. 9 is a block diagram of a fourth portion of the system of FIG. 4;

FIG. 10 is a block diagram of a fifth portion of the system of FIG. 4;

FIG. 11 is a memory layout; and

FIGS. 12 and 13 are flow diagrams.

### DETAILED DESCRIPTION

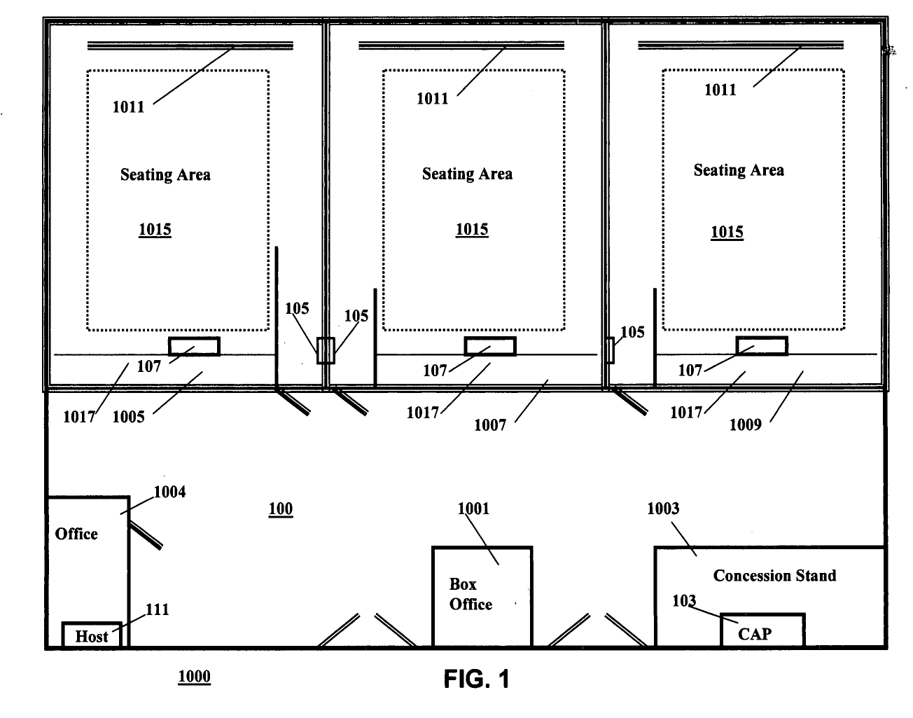

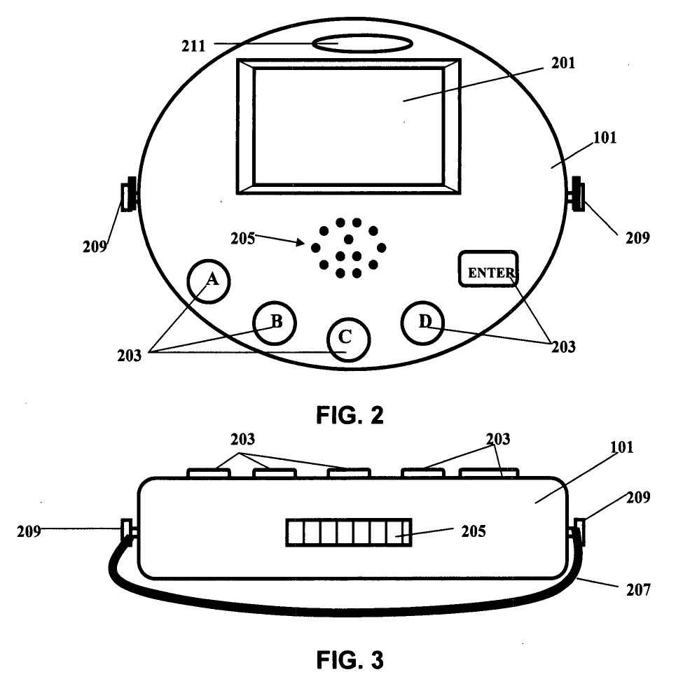

FIG. 1 is a representative multi-screen movie theater complex 1000 to which the invention is advantageously applied. Movie complex 1000 includes a common box office 1001, a concession stand 1003, and an office area 1004. Movie complex 1000 includes three separate movie theaters 1005, 1007, 1009. Although three movie theaters are shown, it will be appreciated by those skilled in the art that the present invention may be advantageously applied to movie theater complexes having fewer or more movie theaters. Each movie theater includes a screen 1011, one or more seating areas 1015, and a projection area 1017.

It will be appreciated by those skilled in the art that the particular configuration of the movie theater complex 1000 shown is merely representative of a movie theater complex and the particular movie theater complex shown is not intended in any way to limit the scope or definition of the present invention.

System 100 is provided in theater complex 1000 and provides an inexpensive platform for consumer interaction.

System 100 of the invention provides an interactive environment for patrons in a theater environment that does or does not utilize digital projection technology.

In accordance with an aspect of system 100, incentives from companies advertising their products can be tied to consumer responses and involvement.

System 100 is configured such that each movie theater in the complex may have a different advertising campaign and/or interactive script.

As used herein, the term “script” is understood to include the combination of a software program and system data used by the system 100 and handheld devices 101 to control the interactive elements of the advertising campaign.

Typical of script data used by system 100 is:
Listing of advertisement segment identifications;
Audio direction clips;
Speech capture control information per segment; and
Radio link control information per segment.

Typical script data utilized by handheld devices 101 is:
Listing of advertisement segment identifications;
Handheld device button functions for each segment and associated actions to be taken;
Speech capture/microphone control information per segment;
Audio Clips with associated segment assignments; and
Radio link control info per segment.

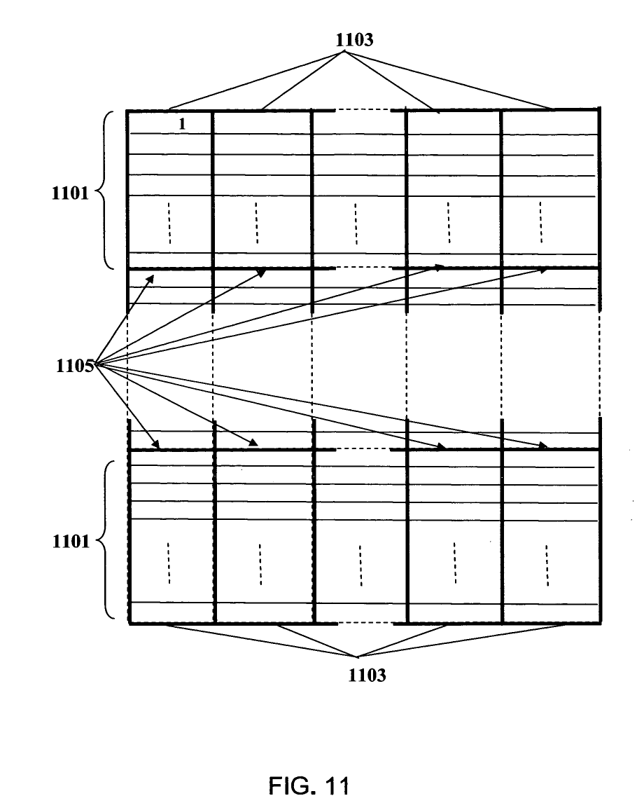

System 100 and handheld devices 101 along with the projection system provide an advertisement experience referred to as the advertisement campaign. Each theatre 1005, 1007, 1009, in a complex 1000 may have a unique campaign. A number of different campaigns 1101 are stored in the advertisement database 113 and are selectively transferred to the memories 107 of theater masters 107. A representative organization of campaigns 1101 in advertisement database 113 is shown in FIG. 11. It will be understood by those skilled in the art that the illustrative representation of FIG. 11 is not intended in any way to limit the spirit or scope of the invention. Many ways of organizing and storing campaign information are possible. A single campaign 1101 consists of 1 to N advertisement sequences 1103 played in order one after the other, or in an interlaced fashion. An advertisement sequence relates to a company or product promotion. An advertisement sequence 1103 may have 1 to M advertisement segments 1105. An advertisement segment 1105 is the least reducible element, the building blocks.

When sequences 1103 are played in an interlaced fashion, system 100 and handheld devices 101 execute a number of advertisement segments 1105 from one company followed by any number of advertisement segments 1105 from another company, and so on, until the advertisement sequences 1103 for all companies is complete.

System 100 of the present invention may be characterized as being “dynamically adaptive,” i.e., system 100 has the capability to modify the style and activity of an advertising sequence 1103 in real time in response to audience response data from handheld devices 101.

Dynamically adaptive system 100 is advantageously utilized with both an open loop projection system (OLPS), and a closed loop projection system (CLPS). An OLPS is not responsive to receive real time inputs and cannot modify its video or audio output accordingly. In contrast a CLPS can do both.

By operating system 100 as a dynamically adaptive system the style of advertisements, and the kinds of incentives offered is matched to the type and mood of the people in the audience. Throughout an advertising campaign system 100 will periodically present an audience with questions which will elicit responses that suggest what kinds of people are participating and what state of mind might they be in. System 100 includes an audience profiler function to determine the type and mood of the audience. In the specific embodiment of the invention the profiler function utilizes 3 criteria, each with 3 possible states, for characterizing an audience:

(1) Age Range—young, middle-aged, old

(2) Personality Type—artistic, athletic, intellectual

(3) Mood—happy, indifferent, sad

With three criteria and three states, there are 27 unique categories.

Audience profiler 125 utilizes the projection system to pose questions. Audience profiler 125 collects audience responses to questions asked. and determines one of the categories which best describes the current audience.

Audience profiler 125 periodically queries the audience for a response to a question, image, sound, or any combination of the three. Two or more such queries will be made for each criterion and will be run periodically because patrons enter the theatre serially in random amounts, thereby continuously changing the audience profile. Once queries are complete for the three criteria, audience profiler 125 uses an algorithm to determine the best-fit state for each criterion. Based upon the chosen states, the appropriate category is assigned and is distributed to the projection system 109a, and to handheld units 101. Projection system 109a selects a specific advertising sequence for each company or vendor based upon the category. Handheld units 101 use the new category to adjust the handheld script.

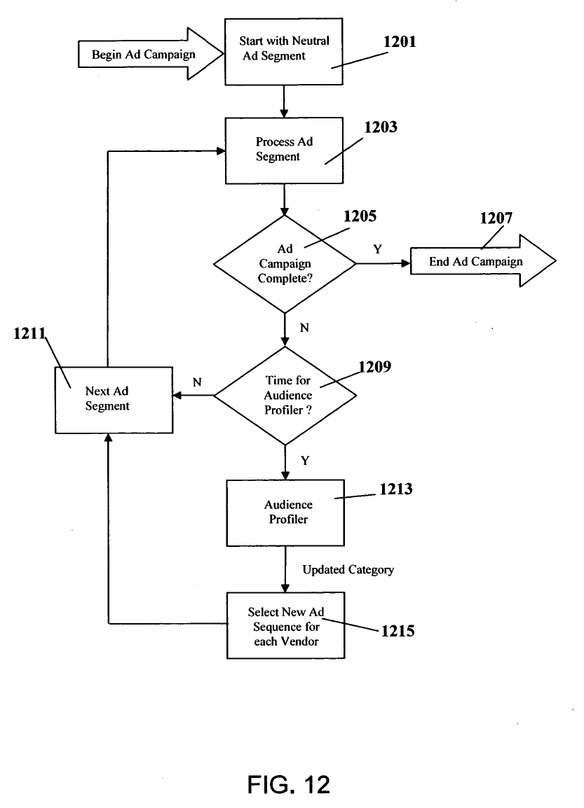

FIG. 12 illustrates the operation of system 100 in executing an advertising sequence 1103. The advertising campaign begins by starting an advertising segment 1201. System 100 the processes advertising segment at step 1203. A determination is made at step 1205 to determine whether the campaign is complete. If the campaign is complete, the system exits the campaign at 1207. If the campaign is not complete, a determination is made as to whether it is time for execution of the audience profiler function at step 1209. If it is not time to execute the audience profiler, the next advertising segment 1201 is obtained at step 1211, and the process is repeated. If however, at step 1209 it is determined that it is time for the audience profiler function to be executed, the audience profiler function is executed at step 1213. Upon completion of the audience profiler function the category is updated and a new advertising sequence is selected for each vendor at step 1215. The process is then repeated by obtaining the next advertising segment.

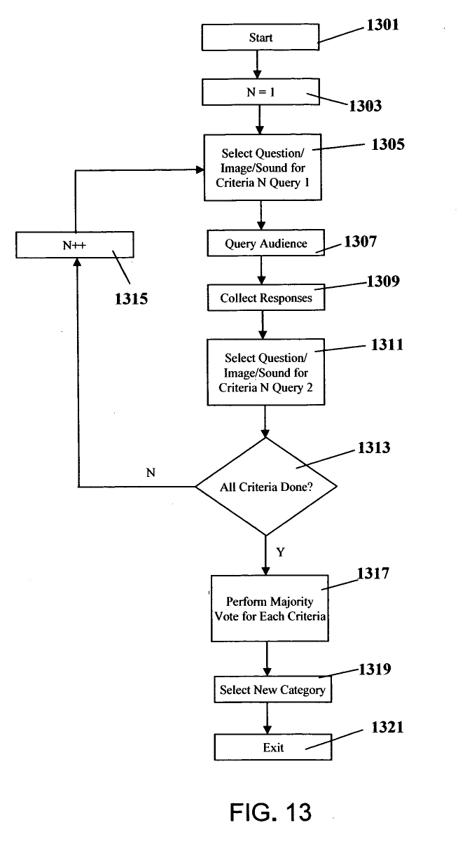

FIG. 13 illustrates operation of the audience profiler function provided by system 100. The profiler function is started at step 1301 and an initial criteria N is selected at step 1303. A query basis for the criteria is selected at step 1305. At step 1307, system 100 queries the audience. Responses to the query are collected at step 1309. A new query for the criteria is selected at step 1311. A determination is made at step 1313 as to whether all the criteria are completed. If not, a new criterion is selected at step 1315 and the process is repeated. If all the criteria are completed at step 1313, a majority vote is made for each of the criteria at step 1317. A new category is selected at step 1319 and the profiler is exited at step 1321.

A significant aspect of the present invention is the utilization of handheld devices 101. The handheld devices 101 are normally stored at a central and patron convenient location in the movie theater complex 1000. In the illustrative embodiment of the invention, handheld devices 101 are stored at a concession stand 103.

When a patron desires to participate in the interactive features, the patron will obtain a handheld device 101 from the concession stand 103. At concession stand 103, a handheld device 103 will be charged up and will be programmed.

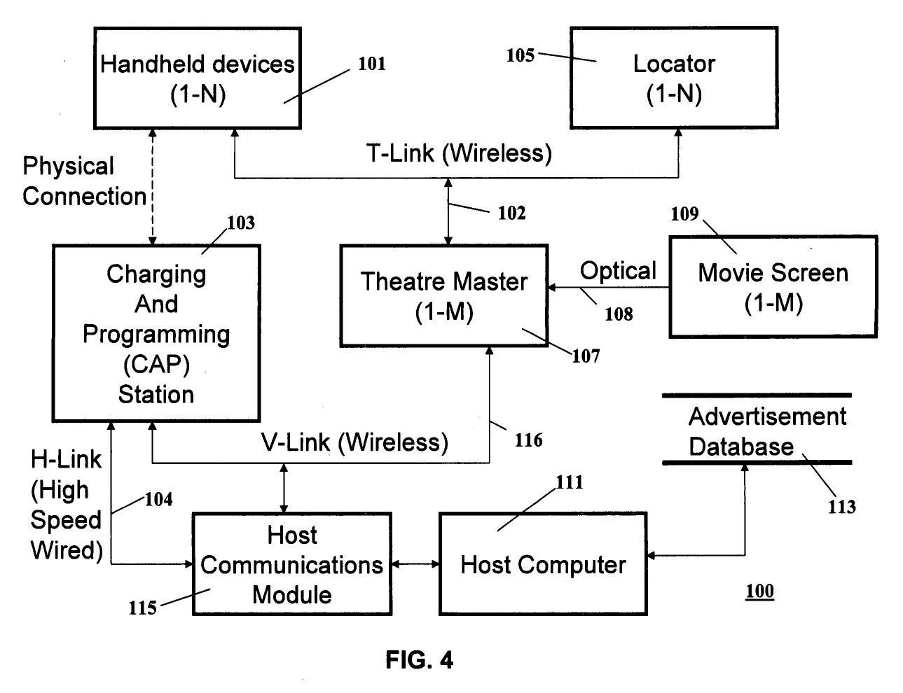

Handheld device 101 is what a theater patron uses to interact with a system 100 shown in block diagram form in FIG. 4. Each handheld device 101 includes a display 201, which may be any available display such as a LCD type display, buttons 203, a transducer for providing scripted audio playback, and a physical interface 205 to a charging programming station 103 shown in FIG. 4. Interface 205 comprises a connector in the illustrative embodiment, but in other configurations of the invention, interface 205 may comprise a wireless interface of types that are known in the electronics arts. The transducer is disposed in the housing of handheld device 101 and is not shown, but is disposed proximate apertures 205. Handheld device 101 includes an elastic strap 207 that is affixed to studs 209. The strap makes it easier for the theater patron to carry handheld device 101. It should be noted that the particular shape and configuration of handheld device 101 may be changed without departing from the inventive principles.

A microphone 625 and associated circuitry in the handheld device 101 provides the capability to record solicited patron verbal responses referred to as speech capture. In one use, a message on the movie screen will ask the audience to repeat a phrase which will be captured via microphone 625. The phrase may or may not have anything to do with an ad. Alternatively, it may be for entertainment purposes only. Theater master 107 will retrieve selected captured responses, analyze the captured speech to ensure the correct phrase was elicited, select a speech response, and direct the playback of the selected response to the audience. The selection process will be part of the script and can vary from script to script.

When system 100 is utilized with a non-digital projection system, audience response data is captured and used by system 100 to determine winners of incentives offered and to possibly modify the behavior of the script in the handheld device 101. The data will also be compiled and delivered to the ad agency for their analysis.

When system 100 is utilized with a digital projection system, there is another valuable use of the audience response data collected from handheld devices 101 in addition to the above mentioned uses. The solicitations in the ad being displayed on the screen can be constructed in such a way as to garner audience demographics and emotion by creating the proper stimulus via the add sequence. The demographic and emotional state information would be fed back in the audience response data to modify the output of the projection system.

Handheld device 101 is powered by one or more capacitors 601 as shown in FIG. 6. Capacitors 601 are of the type commonly referred to as super or ultra capacitors which are commercially available. Super capacitors advantageously provide high capacitance values in small volume packages. In the past, super capacitors have typically been utilized as secondary or backup power sources to provide limited power to circuits in the event of power interruptions. In the present invention, capacitors are utilized as the primary power source for the handheld device 101. Capacitor 601 may be charged to maximum capacity in a short period of time by utilizing a charging and programming (CAP) station 103. When charged to capacity, handheld device 101 can operate for over 5 hours before needing to be recharged. In the illustrative embodiment, capacitor 601 can be charged to capacity in 20 seconds by CAP station 103.

The use of super capacitors is particularly advantageous compared to conventional batteries which need to be replaced frequently. Super capacitors are also advantageous over rechargeable batteries which would need to be replaced every 2 years or so, but more importantly take a relatively long time to be charged. If rechargeable batteries were utilized multiple sets of handheld devices 101 would have to be circulated through large arrays of charging cradles in order to meet the on-demand load. Super capacitors do not need replacement and can be quickly charged.

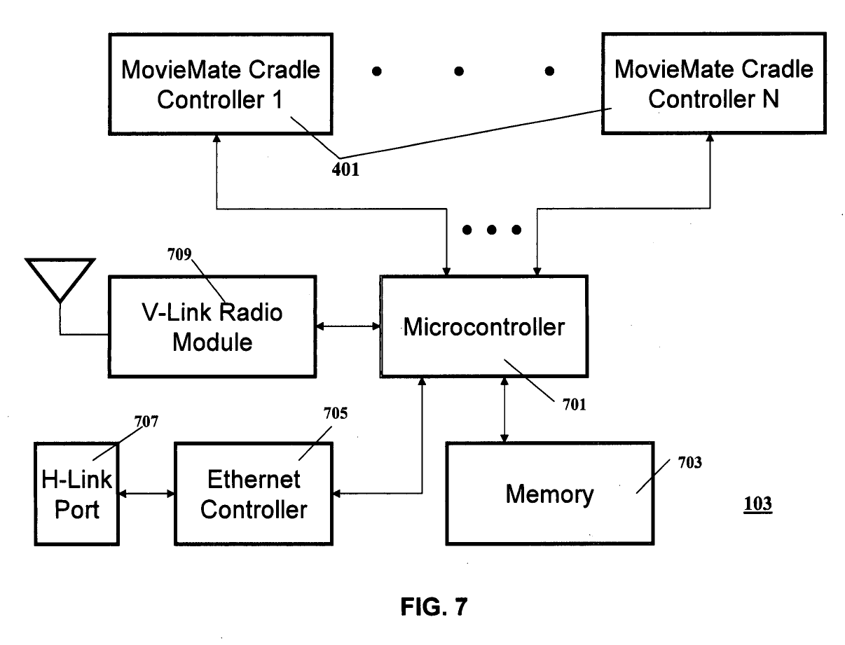

CAP station 103, as shown in FIG. 7, includes a plurality of docking stations or cradles 401 for receiving handheld devices 101 for charging and programming. A microcontroller 701 with associated memory 703 receives downloaded data from host computer 111 via an Ethernet controller 705 and an H-link port 707. CAP station 103 also includes an RF module 709 for receiving concession orders from handheld devices 101 via the theater masters 107.

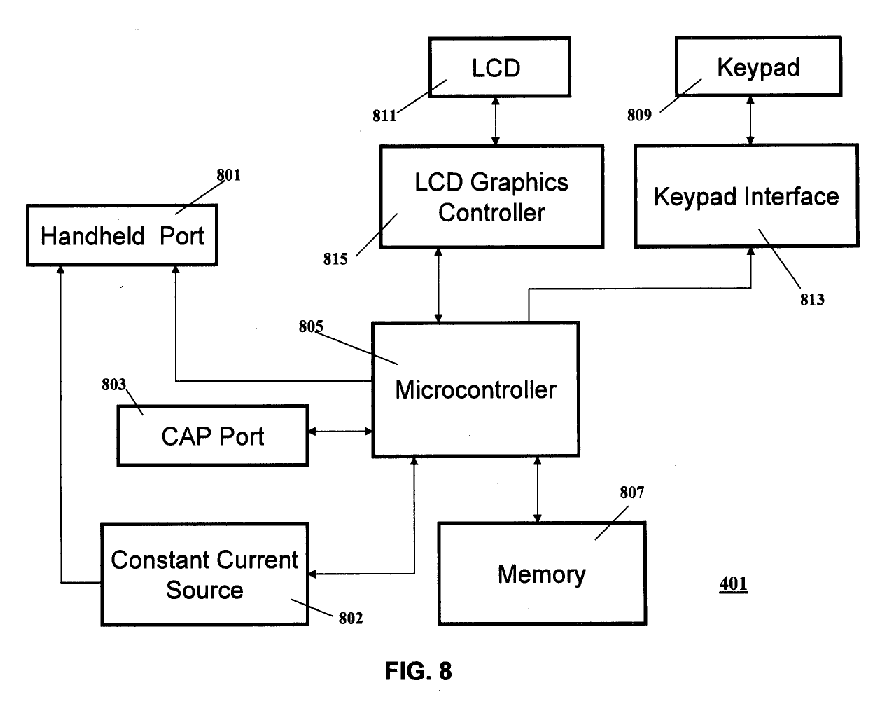

Each cradle 401, as shown in FIG. 8, includes a port 801 into which a handheld device 101 is coupled, and a port 803 to which the cradle couples to CAP station 103. A constant current source 802 is provided for fast charging handheld devices 101. Microcontroller 805 and associated memory 807 are provided to program each handheld device 101 inserted into the cradle. Handheld device 101 also includes indicators or lights. A red visual indicator is activated to indicate that handheld device 101 is charging and is being programmed. A green visual indicator is used to indicate that handheld device 101 is ready for use and should be removed from the cradle.

Handheld device 101, as shown in FIG. 6, includes a power regulation and control circuit 603 that is used to ensure that super capacitor 601 is discharged at an appropriate voltage. A microcontroller 605 and memory 607 are provided to operate handheld device 101. Cap port 205 as described above is utilized at CAP Station 103 to both charge capacitor 601 and to download firmware updates and data to microcontroller 605 and memory 607. Microcontroller 605 is coupled to user buttons 203, display 210 and to audio circuits 609 to provide the user interface. A radio frequency module 611 provides wireless access to a corresponding theater master 107.

Each theater 1005, 1007, 1009 includes a theater master unit 107. The theater master unit 107 includes an optical receiver that is optically coupled via an optical link 108 to the respective theater screen 1011. Optical link 108 provides for the decoupled command and synchronization of the ads displayed on screen 1011 to system 100 via optical frame encoding (OFE). This precludes the need for adding any electronics to link the theater projection system to system 100. Any information needed to synchronize the system 100 to the projected advertisement, or guide the ad experience, can be sent optically by incorporating OFE in the actual video of the advertisement being presented. An optical frame encoder (OFE) computer program is used to insert the needed frames into an ad campaign. An optical detecting device 505 contained in the theatre master unit 107, is used to detect and decode the OFE frames.

System 100 also incorporates a locator feature. The locator feature provides for a “concession” mode and a “finder” mode. In addition, system 100 also provides for the theatre membership function by configuring the handheld units as the patrons enter the theatre via a short range radio link.

To provide the locator feature, a unique code is associated with each handheld device 101. An input device or terminal 105 is located inside the entrance to each theater 1005, 1007, 1009; and an optical device 211 such as a light emitting diode in handheld device 101 is capable of flashing on command. When someone wishes to locate a member in the audience possessing a handheld device 101, they can do so by entering the unique code at the input device 105. Handheld device 101 will begin to flash, and will continue to do so for a predetermined period of time.

In the concession mode, food from the concession stand 1003 can be ordered from the handheld devices 101 while the patron is in the theater 1000. The locator feature can be used to inform the patron to get up and meet the theater worker at the theater entrance to get their food, or the theater worker can deliver the food items directly to the customer. Also, if the incentives that are offered are concession food items, they can be delivered to the incentive winners as the movie starts using the locator feature.

In the “finder” mode, a person entering a dark theater can easily locate their party in the audience.

System 100 as shown in FIG. 4 includes central database 113. Central host computer 111 is provided in the theater complex and provides access to database 113. Host computer 111 is utilized to update and change database 113.

Host computer 111 is connected to CAP station 103 and theater masters 107 in the theater complex or venue via a wireless connection 116, referred to as the V-Link. A system operator can change the personality of system 100 on the fly by downloading, to host computer 111, new firmware for theater master 107, handheld devices 101, CAP station 103, and locators 105; and by downloading various advertisement scripts, audio clips, and handheld device configuration data which is stored in database 113. Host computer 111 distributes updates to all theater masters 107 and CAP station 103.

Host computer 111 provides an interference avoidance mode to periodically measure the RF interference in their environments. Host computer 111 obtains RF measurement data and determines new channel sets which avoid the interference for all the theater masters 107.

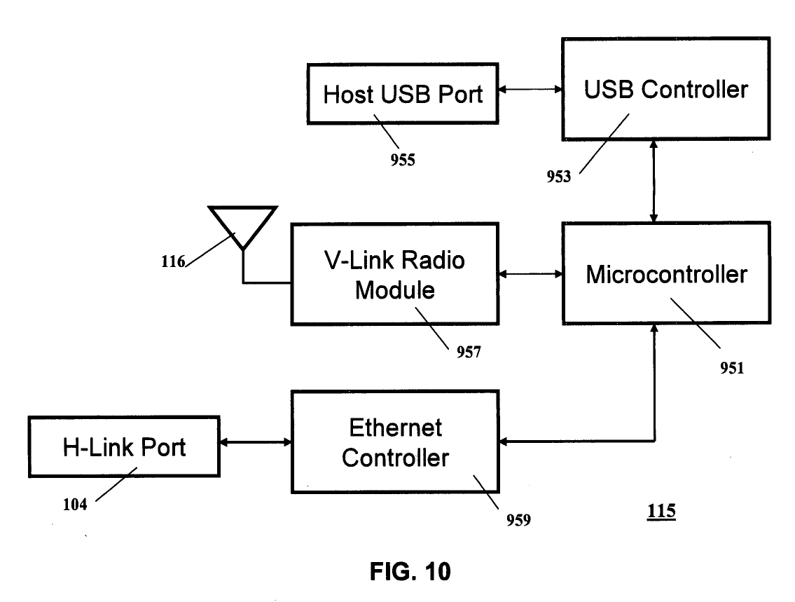

Communications module 115, shown in FIG. 10, provides the communications interface between host computer 111 and V-link wireless connection 116, and between host computer 111 and high speed wired link, or H-link 104 to CAP station 103. Communications module 115 includes a microcontroller 951 that controls communications between the host computer 111 via USB port 955 and USB controller and a radio or RF module 957 to the wireless link and between the host computer 111 and the hard wired link to the CAP station via an Ethernet controller module 959.

Prior to a customer receiving a handheld device 101 from concession stand 1003, CAP station 103 charges and configures handheld device 101. In addition, advertisement scripts and audio clips for the selected theater are downloaded from database 113 into handheld device 101. After configuration is complete, the particular handheld device 101 operates in a first mode identified as a “membership mode”. In the membership mode, handheld device 101 listens for a locator 105 to broadcast theatre identification information. As the customer comes in range of the specific theater locator 105, handheld device 101 receives a short range broadcast message from locator 105 and uses this message to configure the radio receiver of handheld device 101 to the channel set utilized by that theater's theatre master 107. Theatre master 107 uses a unique channel as a membership channel and another unique channel as an operational channel. Handheld 101 will first set itself to the membership channel and respond to membership queries from theatre master 107. Once membership is granted by a theatre master 107, handheld device 101 will switch its radio to the operational channel of theatre master 107 and enters an active mode.

Handheld device 101 in the active mode responds to periodic communications from the corresponding theater master 107 over wireless T-link 102. These periodic communications from theater master 107 are referred to as “Theater Beats”. Theater master 107 sends synchronization data, advertisement identification, audio playback commands, and locator requests in these periodic communications. In addition, theater master 107 receives data from handheld device 101 that indicates activation of switches 203 and may include concession orders.

Handheld device 101, in the active mode, processes preloaded dynamically adaptable advertisement scripts. When a theater beat is received from the theater master 107, hand held device 101 selects the advertisement program corresponding to an advertisement identification sent in the theater beat. The preloaded dynamically adaptable script is used by handheld device 101 to determine which buttons or switches 203 to monitor for responses to the advertisement scripts, which audio clips to play and the time to play them, and what data, if any, should be transmitted to theater master 107 in unsolicited response messages.

Handheld device 101, in the active mode, also processes locator requests by flashing its optical output device 211.

Handheld device 101, in the active mode, maybe utilized to display, on display 201, the concession menu, build a concession order and, sending the concession order to the theater master 107. Theater master 107 forwards all concession orders to CAP station 103.

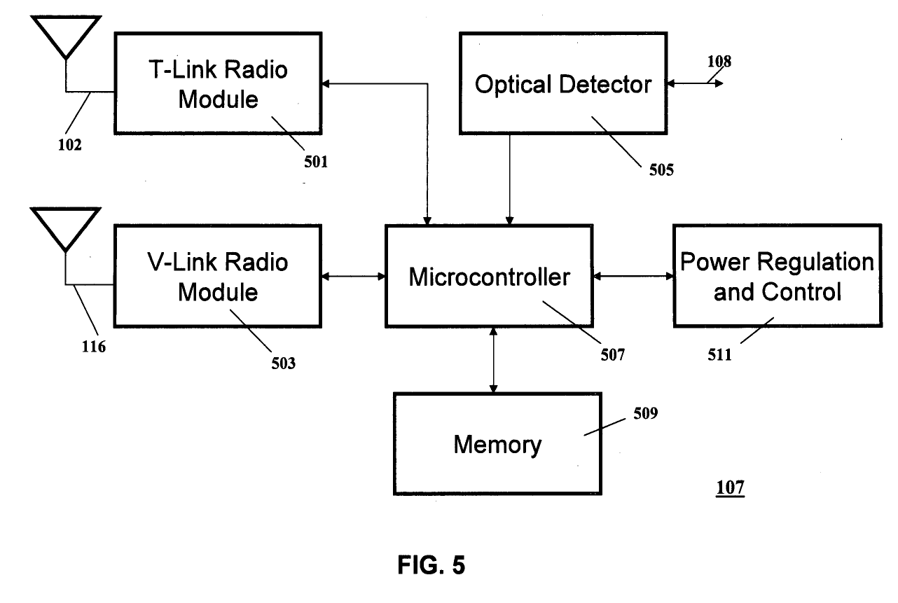

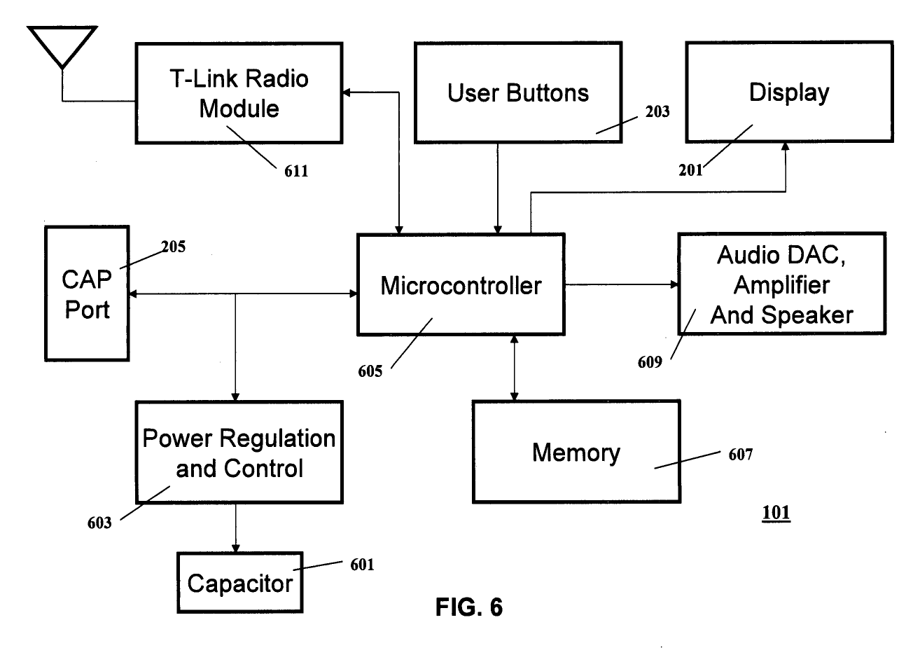

Each theater master 107 is a small unit mounted on the back wall of the respective movie theater 1005, 1007, 1009 above the movie projector window as illustrated in FIG. 1. Each theater master 107 communicates with every handheld device 101 assigned to the particular theater as described above. In addition, theater master 107 polls the respective locator 105 for locator inquiries, optically monitors the movie screen via an optical detector 505 for OFE transmissions, and performs periodic RF interference avoidance measurements for host computer 111. Each theater master 107, as shown in FIG. 5, includes two radio modules 501, 503 for wireless communication to handheld devices 101 and locators 105 via T-link 102, and host computer 111 and CAP station 103 via V-Link 116, respectively. Each theater master includes a microcontroller 507 and associated memory 509 and a power module 511. Microcontroller 507 may be selected from any number of commercially available microcontrollers. Memory 509 is utilized to store advertisement programs preselected for the associated movie theater.

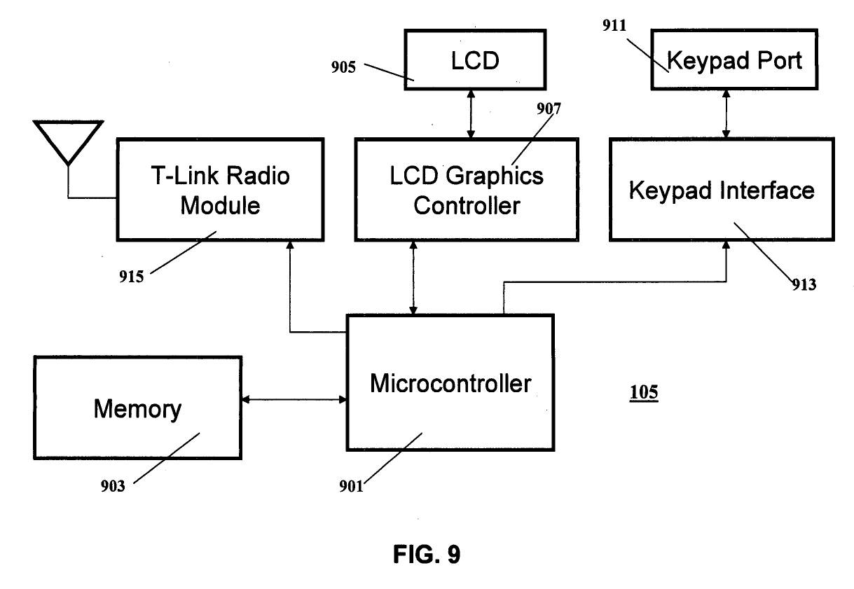

There is one locator 105 for each entrance into a theater 1005, 1007, 1009. Each locator 105 is disposed on the wall at the theater entrance, inside the theater. Each locator 105, as shown in FIG. 9, includes a microcontroller 901 and memory 903. Locator 105 includes a display 905 that is driven by microcontroller 901 via a graphics controller 907. Locator 105 includes a keypad 911, interfaced to microcontroller 901 via an interface 913. Keypad 913 is utilized to input identities of handheld units 101. Microcontroller 901 transmits identity inputs to a corresponding theater master 105 via a RF module 915 over T-link 102 when the corresponding theater master 105 polls locator 105.

CAP station 103 located at concession stand 1003 charges up the capacitor in each handheld device 101 when the handheld device is inserted into the CAP station 103. An authentication process is used between the handheld device 101 and CAP station 103 before charging begins. CAP station 103 has the capability of re-programming handheld devices 101 so that the functionality of each handheld device 101 can be changed at any time of the day. An indicator red light allows the concession workers to know that the handheld is properly connected, is being charged and programmed. A green light allows the concession workers to know that the handheld device 101 is ready for use. CAP station 103 communicates with host computer 111 via wireless V-link 116 to receive firmware updates, advertisement scripts, audio clips, configuration data, customer incentive status, and customer account status for in-theater concession orders.

With system 100 a sort of “animated” or “reality based advertising” can be achieved. The audience becomes actively involved with the ad, transforming it into a drama/comedy unique to that audience at that time.

When theaters eventually appropriate digital projection technology, future functionality such as interactive movies, real-time advertising, and interactive group video games can be added to the suite of features.

The invention is described in terms of a specific illustrative embodiment. It will, be apparent to those skilled in the art that various changes and modifications can be made to the described embodiment without departing from the spirit or scope of the invention. More specifically, it will be apparent to those skilled in the art that the present invention may be utilized to provide interactive movies and interactive games. It will be further apparent to those skilled in the art that the present invention may also be utilized in theme park systems as well as in general entertainment venues.

It is intended that all such changes and modifications be included in the invention as claimed below. It is not intended that the illustrative embodiment limit the scope of the invention. It is intended that the invention be limited only by the appended claims, giving each of those claims the broadest possible scope permitted under the law.

What is claimed is:

1. A portable electronic device, comprising:
electronic circuitry;
a primary power supply for said electronic circuitry, said primary power supply comprising a high capacitance, low volume capacitor, said capacitor being the sole power source for said electronic circuitry.

2. A portable electronic device in accordance with claim 1, wherein:
said electronic circuitry comprises a communications module for communicating via communication signals over a wireless communication link.

3. A portable electronic device in accordance with claim 1, wherein:
said electronic circuitry comprises one or more manual inputs.

4. A portable electronic device in accordance with claim 3, wherein:
said electronic circuitry comprises a display.

5. A portable electronic device in accordance with claim 1, comprising:
a housing containing said electronic circuitry and said primary power supply, said housing being sized to permit said portable electronic device to be easily carried by a user of said portable electronic device.

6. A portable electronic device in accordance with claim 5, comprising:
an interface apparatus to couple an external high current charging source to said super capacitor.

7. A portable electronic device in accordance with claim 6, wherein:
said electronic circuitry comprises a microcontroller and a memory.

8. A portable electronic device in accordance with claim 7, wherein:
said interface apparatus provides a communication link to said memory such that said memory may be loaded with a predetermined script.

9. A portable electronic device in accordance with claim 8, wherein:
said electronic circuitry comprises a wireless communication module.

10. A portable electronic device in accordance with claim 9, wherein:
said wireless communication module, said microcontroller and said memory cooperate to synchronize operation of said portable electronic device with external influences.

11. A portable electronic device in accordance with claim 1, wherein:
said electronic circuitry comprises a microcontroller and a memory.

12. A portable electronic device in accordance with claim 11, wherein:
said interface apparatus provides a communication link to said memory such that said memory may be loaded with a predetermined script.

13. A portable electronic device in accordance with claim 12, wherein:
said electronic circuitry comprises a wireless communication module.

14. A portable electronic device in accordance with claim 13, wherein:
said wireless communication module, said microcontroller and said memory cooperate to synchronize operation of said portable electronic device with external influences.

15. A portable electronic device in accordance with claim 1, wherein:
said electronic circuitry comprises a wireless communication module.

16. A portable electronic device in accordance with claim 15, wherein:
said electronic circuitry comprises a memory for storing user specific information.

17. A portable electronic device in accordance with claim 15, comprising:
a light source, said light source being selectively operable in accordance with signals received by said wireless communication module that coincide with at least a portion of said user specific information.

18. A portable electronic device in accordance with claim 15, wherein:
said electronic circuit comprises a display, said display being utilized to display a menu;
said device comprising input apparatus, said input apparatus being utilized to select items from said displayed menu and to cause said wireless communication module to transmit said selected items and at least a portion of said user specific information to identify the user.

19. A portable electronic device in accordance with claim 1, wherein:
said capacitor has a capacitance of at least one farad.

20. A portable electronic device in accordance with claim 1, comprising:
an interface apparatus to couple said super capacitor to an external high current charging source.
